(19) United States
(12) Patent Application Publication
(10) Pub. No.: US 2005/0094894 A1
(43) Pub. Date: May 5, 2005

(54) Image processing device, image processing method, and program therefor

(75) Inventor: Makoto Yonaha, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/946,075

(22) Filed: Sep. 22, 2004

(30) Foreign Application Priority Data
Sep. 22, 2003 (JP) 2003-330041

(51) Int. Cl. G06K 9/40; H04N 5/217

(52) U.S. Cl. 382/275; 348/241

(57) ABSTRACT

The image processing device includes an unit for generating plural processed images from a single input image, an identifying unit having identifying function and dictionary data for the identifying function and processing the processed image using a combination of an identifying function corresponding to a target object and the dictionary data for the identifying function to detect the target object in the input image and an unit for calculating positional coordinates of the target object in the input image using a result of detecting the target object.

### BACKGROUND OF THE INVENTION

The present invention relates to an image processing device and an image processing method for performing detection (recognition) of objects in an image, such as red-eye detection, and to a program for executing the image processing method.

Recently, digital photoprinters are in practical use. The digital photoprinter photoelectrically reads an image taken on a film, digitizes the read image, applies various types of image processing to generate image data for recording, exposes a photosensitive material with recording light modulated according to the image data, and outputs the image as a print.

The digital photoprinter thus photoelectrically reads an image taken on a film, converts the image into digital image data, and then performs image processing and photosensitive material exposure using the digital image data. It is therefore possible to produce a print not only from an image taken on a film but also from an image (image data) taken by a digital camera etc.

Also, recently, as personal computers (PCs), digital cameras, and inexpensive color printers such as ink-jet printers are in wide use, many users capture images taken with digital cameras into PCs, apply image processing thereto, and output the images with printers.

Furthermore, some printers recently in practical use are capable of reading image data directly from a storage medium storing images taken by a digital camera, such as SmartMedia™ or CompactFlash™, applying certain image processing thereto, and outputting a print (a hard copy).

Now, with an image containing a human subject, e.g., a portrait, the most significant factor that affects an image quality is how the human subject is finished. Therefore, a red-eye phenomenon, in which human eyes (pupils) appear red due to strobe flashlight during photographing, is a serious problem.

Red-eye correction is extremely difficult with conventional photoprinters that perform exposure directly from a film. However, in digital image processing, e.g., with digital photoprinters, red-eye correction can be achieved by detecting red-eye by image processing (image analysis) and converting the image data of the red-eye region or correcting color/density of the red-eye region. Various methods have thus been proposed to detect red-eye in images by image processing.

For example, JP 2002-247596 discloses a method of identifying a red-eye region. In this method, in a target region that contains an eye region in an image, characteristic regions including an iris region are detected on the basis of the quantities of characteristics, and the red-eye region is identified on the basis of a positional relationship between the iris region and other characteristic regions, for example, how the iris region contacts the other characteristic regions, an area ratio between the target region and the red-eye region, and a containment relationship between the iris region and another region (e.g., a pupil region).

JP 2003-36438 discloses another method of identifying a red-eye region. In this method, in a target region that contains an eye region in an image, a plurality of characteristic regions including an iris region (red-eye region candidates) are detected on the basis of the quantities of characteristics, including hue, chroma, and lightness, and the red-eye region is identified on the basis of how the iris region contacts other characteristic regions, gradation properties of characteristics of the characteristic regions, and area information of the characteristic regions.

The red-eye phenomenon is peculiar to natural objects like humans and animals. Now, images (image data) of natural objects like humans and animals greatly vary depending on various conditions. That is to say, in image processing of natural objects, targets to be processed, such as size, luminance/density, distortion, etc., largely vary depending on various conditions.

For example, the size of an object in an image largely varies depending on the photographing distance. Also, the color, density, and luminance of an object, e.g., a face, vary depending on how it is lighted in different weather conditions and different locations. Moreover, object colors differ among different races and depending on the color of photographing light.

Conventional red-eye detecting methods (algorithms) including those disclosed in the patent documents cited above can suitably perform red-eye detection under particular conditions.

However, in the case of natural objects, targets to be processed assume various conditions as stated above. The conventional red-eye detecting methods are therefore unable to properly deal with the targets to be processed under such various conditions to suitably perform red-eye detection.

### SUMMARY OF THE INVENTION

The present invention has been made to solve the above-described problems of conventional art, and an object of the present invention is to provide an image processing method and an image processing device which are capable of properly performing detection of objects in an image, e.g., red-eye detection, with respect to natural objects under various conditions and also capable of achieving a balance between higher speed and higher reliability according to required productivity, processing precision, etc., and to provide a program for executing the image processing method.

In order to attain the object described above, the first aspect of the invention provides an image processing device, comprising processed image generating means for generating plural processed images from a single input image, identifying means having at least one identifying function and at least one piece of dictionary data for each of the at least one identifying function and processing each of the plural processed images generated by the processed image generating means using a combination of an identifying function corresponding to a target object in the at least one identifying function and the at least one piece of dictionary data for the identifying function to detect the target object in the single input image, and coordinate calculating means for calculating positional coordinates of the target object in the single input image using a result of detecting the target object by the identifying means.

Preferably, each of the plural processed images includes at least one of an enlarged image of the single input image, a reduced image of the single input image, and a turned image obtained by turning the single input image.

Preferably, the identifying function includes at least one of a first identifying function for detecting a face and a second identifying function for detecting an eye, and the dictionary data includes at least one of first dictionary data for a race, second dictionary data for a gender, third dictionary data for an age, fourth dictionary data for weather, fifth dictionary data for a species of creature, and sixth dictionary data for a particular subject for photographing.

It is preferable that the image processing device further comprises at least one of changing means for changing number of the plural processed images generated by the processed image generating means and adjusting means for adjusting processing performed by the identifying function.

The second aspect of the invention provides an image processing device, comprising identifying means having at least one identifying function that is set for one of plural images obtained by geometrically deforming an input image and at least one piece of dictionary data for each of the at least one identifying function and processing the input image using a combination of an identifying function corresponding to a target object in the at least one identifying function and the at least one piece of dictionary data for the identifying function to detect the target object in the input image, and coordinate calculating means for calculating positional coordinates of the target object in the input image using a result of detecting the target object by the identifying means.

Preferably, each of the plural images obtained by geometrically deforming the input image includes at least one of an enlarged image of the input image, a reduced image of the input image, and a turned image obtained by turning the input image.

Preferably, the identifying function includes at least one of a first identifying function for detecting a face and a second identifying function for detecting an eye, and the dictionary data includes at least one of first dictionary data for a race, second dictionary data for a gender, third dictionary data for an age, fourth dictionary data for weather, fifth dictionary data for a species of creature, and sixth dictionary data for a particular subject for photographing.

It is preferable that the image processing device further comprises at least one of changing means for changing number of the plural images obtained by geometrically deforming the input image and adjusting means for adjusting processing performed by the identifying function.

In order to attain the object described above, the first aspect of the invention provides an image processing method, comprising the steps of setting in advance at least one identifying function and at least one piece of dictionary data for each of the at least one identifying function, generating plural processed images from a single input image, processing each of the plural processed images generated by the generating step using a combination of an identifying function corresponding to a target object in the at least one identifying function set in advance and the at least one piece of dictionary data for the identifying function, detecting the target object in the single input image, and calculating positional coordinates of the target object in the single input image using a result of detecting the target object by the detecting step.

The second aspect of the invention provides an image processing method, comprising the steps of setting in advance at least one identifying function for one of plural images obtained by geometrically deforming an input image and at least one piece of dictionary data for each of the at least one identifying function, processing the input image using a combination of an identifying function corresponding to a target object in the at least one identifying function and the at least one piece of dictionary data for the identifying function, detecting the target object in the input image, and calculating positional coordinates of the target object in the input image using a result of detecting the target object by the detecting step.

In order to attain the object described above, the first aspect of the invention provides a program for executing an image processing method, the image processing method comprising a step of setting in advance at least one identifying function and at least one piece of dictionary data for each of the at least one identifying function, a step of generating plural processed images from a single input image, a step of processing each of the plural processed images generated by the generating step using a combination of an identifying function corresponding to a target object in the at least one identifying function set in advance and the at least one piece of dictionary data for the identifying function, a step of detecting the target object in the single input image, and a step of calculating positional coordinates of the target object in the single input image using a result of detecting the target object by the detecting step.

It is preferable that the image processing method further comprises a step of detecting performance of a device in which the program is installed, and at least one step of a step of selecting number of the plural processed images generated by the generating step and a step of adjusting processing performed by the identifying function, according to the detected device performance.

The second aspect of the invention provides a program for executing an image processing method, the image processing method comprising a step of setting in advance at least one identifying function for one of plural images obtained by geometrically deforming an input image and at least one piece of dictionary data for each of the at least one identifying function, a step of processing the input image using a combination of an identifying function corresponding to a target object in the at least one identifying function and the at least one piece of dictionary data for the identifying function, a step of detecting the target object in the input image, and a step of calculating positional coordinates of the target object in the input image using a result of detecting the target object by the detecting step.

It is preferable that the image processing method further comprises a step of detecting performance of a device in which the program is installed, and at least one of a step of selecting number of operations deforming the input image and a step of adjusting processing performed by the identifying function.

Having the above configuration, the present invention can properly perform detection of an object from an image such as detection of red-eye for correcting the red-eye by selecting/switching dictionary data to be combined with identifying functions, for various images (i.e., target objects for image processing) which are different in conditions such as photographing condition, age, region, weather, race and gender.

The present invention can also achieve a balance between higher speed and higher reliability by changing the number of processed images generated or changing parameters in identifying functions according to the device performance and the performance required of the system.

This application claims priority on Japanese patent application No.2003-330041, the entire contents of which are hereby incorporated by reference.

### BRIEF DESCRIPTION OF THE DRAWING

In the accompanying drawing:

FIG. 1 is a conceptual diagram illustrating an embodiment of an image processing device according to the present invention.

### DETAILED DESCRIPTION OF THE PREFERRED EMBODIMENTS

Hereinafter, an image processing device, an image processing method, and a program therefor according to the present invention will be described in detail on the basis of preferred embodiments illustrated in the accompanying drawing.

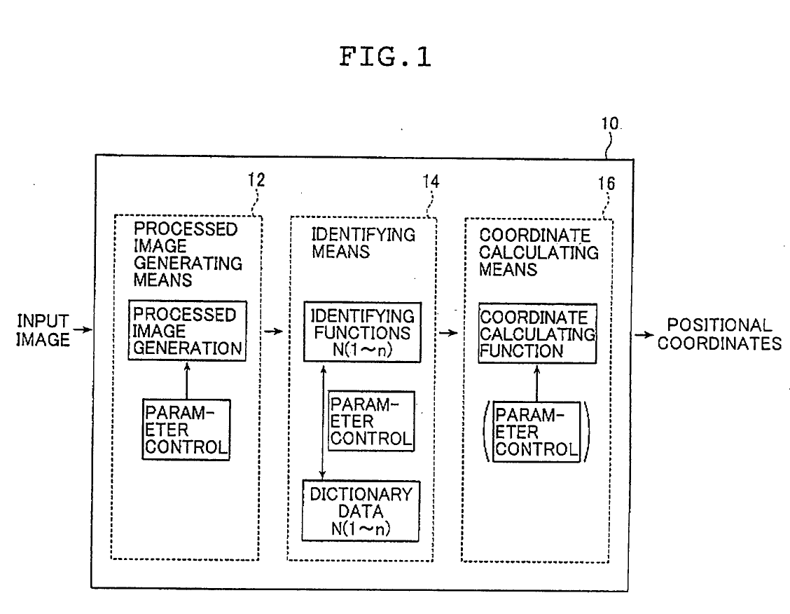

FIG. 1 is a block diagram illustrating an embodiment of the image processing device of the present invention that implements the image processing method of the present invention.

An image processing device 10 of FIG. 1 detects redeye from an input image (input image data) and outputs positional coordinates (positional coordinate data) of the red-eye in the image, which includes processed image generating means 12, identifying means 14, and coordinate calculating means 16. The image processing device 10 can be configured with a computer, such as a personal computer or a work station, or with a DSP (Digital Signal Processor), for example.

In the image processing device 10 shown in FIG. 1 (hereinafter referred to as processing device 10), the input image is, for example, a photographic color image (data), which may be an image taken by a camera using normal photographic film (an image obtained by photoelectrically reading a photographic film) or an image taken by a digital camera.

The input image is supplied to the processed image generating means 12 (hereinafter referred to as generating means 12). The generating means 12 generates, from the input image, processed images for red-eye detection.

In the example of FIG. 1, the generating means 12 generates processed images by enlarging/reducing the input image and by turning the enlarged/reduced images and sequentially sends them to the following identifying means 14.

More specifically, with the input image as scaled 100% (reference image), the generating means 12 enlarges and reduces the input image by 5% pitch (intervals) between a minimum size of 80% and a maximum size of 120% in a sequence of 100%->95%->105%->90%->110% . . . , and sequentially sends the enlarged and reduced images as processed images to the identifying means 14.

Also, while generating enlarged and reduced images, the generating means 12 turns the input image and the generated enlarged and reduced images by 5° pitch between +30° and −30°, with the input image as turned 0° (reference image) in a sequence of 0°->+58°->−5°->+10°->−10 . . . , and sequentially sends the generated images as processed images to the identifying means 14.

The generating means 12 generates two kinds of turned images for each image. One is an image turned (rotated) using a rotation axis perpendicular to the image plane at the center of the image. The other is an image turned (skewed) using a rotation axis on the image plane that is parallel to the shorter side and passes through the middle of the longer side of the image, or a rotation axis on the image plane that is parallel to the longer side and passes through the middle of the shorter side of the image.

In the example of FIG. 1, such two kinds of turned images are generated for the input image and for each of the enlarged and reduced images and sequentially sent to the identifying means 14 as processed images.

In the processing device 10, parameters for the generation of processed images by the generating means 12 can be suitably controlled (adjusted). More specifically, one or more of the enlarging/reducing range, enlarging/reducing pitch, turning range, and turning pitch can be controlled as parameters.

Such parameters may be controlled according to input instructions from an operator, or, as will be described later, the program of the present invention, when installed, may detect performance of the processing device 10 and automatically control the parameters, or both control functions may be prepared so that one of them can be chosen. Also, some modes, e.g., a normal processing mode, a high-speed processing mode, a high-precision processing mode, may be prepared with combinations of controlled parameters to allow operator's proper selection.

The identifying means 14 sequentially processes the processed images supplied from the generating means 12 to detect a red-eye region for each processed image, merges the results of red-eye detection in all processed images, detects a red-eye region in the input image, and supplies the result of red-eye region detection to the coordinate calculating means 16. For example, the identifying means 14 supplies the coordinate calculating means 16 with the red-eye detection result in the form of a mask image indicating the red-eye region (a red-eye candidate region) with data “1” and the remaining region with data “0”.

While the red-eye region may be indicated with such a mask image, the red-eye region may also be indicated with a “data 1” list (a list of coordinate values), for example. The indication of red-eye region is not limited to methods using binary data “0” and “1”, but the possibility of redeye may be indicated with multi-value data, e.g., 8-bit data (0-255).

In the example of FIG. 1, on the basis of the supplied processed images, the identifying means 14 first detects a face, next detects an eye from the detected face region, and then detects a red-eye region from the detected eye. The red-eye detected by the identifying means 14 may of course include a plurality of eyes.

The identifying means 14 has 1-n known identifying functions (known object detecting algorithms) corresponding to individual objects to be detected and at least one piece of dictionary data (reference data) for each identifying function (1-n pieces of dictionary data). The identifying means 14 properly combines an identifying function and dictionary data depending on the object to be detected, and the identifying function detects the object referring to the dictionary data.

For example, the identifying means 14 has a face detector as an identifying function 1, an eye detector as an identifying function 2, and a red-eye detector as an identifying function 3. The identifying means 14 further has face dictionary data obtained by machine learning from a face image group as dictionary data 1 for the identifying function 1, eye dictionary data obtained by machine learning from an eye image group as dictionary data 2 for the identifying function 2, and red-eye dictionary data obtained by machine learning from a red-eye image group as dictionary data 3 for the identifying function 3.

The identifying means 14 first detects a face using the identifying function 1 and the dictionary data 1 in combination, then detects an eye from the detected face region using the identifying function 2 and the dictionary data 2 in combination, and further detects a red-eye region from the detected eye region using the identifying function 3 and the dictionary data 3 in combination. Then, the identifying means 14 supplies a mask image indicating the red-eye region to the coordinate calculating means 16.

In the present invention, the identifying functions and dictionary data are not limited to those shown above. For example, various kinds of dictionary data may be prepared to correspond to different generations.

For example, for the identifying function 1 as a face detector, adult face dictionary data 1-1 may be prepared by machine learning from an adult face image group and child face dictionary data 1-2 may be prepared by machine learning from a child face image group. In this case, when selectively detecting an adult face, the face detection may be performed by the identifying function 1 with the dictionary data 1-1, and when selectively detecting a child face, the face detection may be performed by the identifying function 1 with the dictionary data 1-2.

Needless to say, the various kinds of dictionary data corresponding to different generations may be prepared not only for the face-detecting identifying function but also for the eye-detecting identifying function, and for an identifying function for detecting eye corners, as will be described later.

Also, various kinds of dictionary data may be prepared to correspond to human races.

For example, for the identifying function 2 as an eye detector, Japanese eye dictionary data 2-1 may be prepared by machine learning from a Japanese eye image group and European eye-dictionary data 2-2 may be prepared by machine learning from a European eye image group. In this case, when selectively detecting a Japanese eye, the face detection may be performed by the identifying function 2 with the dictionary data 2-1, and when selectively detecting a European eye, the face detection may be performed by the identifying function 2 with the dictionary data 2-2.

Similarly to the above, it is needless to say that the dictionary data corresponding to human races may be prepared not only for the eye-detecting identifying function but also for the face-detecting identifying function and the like.

Also, as for the identifying functions, detectors for various objects may be prepared as well as the face and eye identifying functions, and various pieces of dictionary data can be used in correspondence therewith.

For example, ordinary red-eye detection is apt to erroneously detect an eye corner as red-eye. Therefore, an eye corner detector may be prepared as an identifying function (which is herein referred to as an identifying function 4 for convenience), with inside eye corner dictionary data 4-1 obtained by machine learning from an inside eye corner image group and with outside eye corner dictionary data 4-2 obtained by machine learning from an outside eye corner image group.

In this case, for example, after an eye is detected by the identifying function 2 as described above, an inside eye corner is detected using the identifying function 4 and the dictionary data 4-1 and then an outside eye corner is detected using the identifying function 4 and the dictionary data 4-2. Then the detected eye corner positions are excluded and the following red-eye detection is carried out.

Various other kinds of dictionary data can be used as well as those shown above. For example, utilizing varying quantities of characteristics of images taken under various conditions and situations, various kinds of dictionary data can be used, such as dictionary data for genders, dictionary data for climate and weather conditions, dictionary data for animals like dogs and cats, and dictionary data adapted for a particular person who will be frequently photographed.

Such dictionary data used in image processing may be selected/set according to input instructions from an operator, or may be set by default.

In the present invention, such identifying functions and at least one piece of dictionary data for each identifying function are separately prepared and an identifying function and dictionary data can be suitably combined and used depending on the object to be detected (i.e. by switching dictionary data). This makes it possible to appropriately detect objects from an image, e.g., red-eye, with various natural objects taken under various conditions, like varying photographing distance, weather, race, age, etc. Also, selecting and switching dictionaries offers high customizability and enables optimization for an arbitrary object to be detected.

Moreover, it is possible to achieve higher performance and customization just by changing or updating dictionaries, which facilitates upgrading.

As well as the generating means 12, the identifying means 14 also allows proper control (adjustment) of object detection parameters.

For example, in order to determine whether certain pixels (or a region) in the image represent the target object or not, an identifying function has, for example, 200 rules (steps for identifying the target object), and identifying steps are sequentially performed by adopting the rules in a given order. When it is determined that the pixels do not contain the target object, the identifying process ends, and when all rules identify the pixels as the target object, those pixels are detected as the object. In the identifying means 14, it is possible to set as a parameter how many of the rules the identifying process should adopt. Also, a threshold for making a determination (a determination criterion) is set for each rule, which can also be controlled as a parameter for each rule.

As in the generating means 12, such parameter control may be performed according to input instructions from an operator or according to detection of the performance of the processing device 10 by the program, or some modes, like a high-speed processing mode, may be prepared. Such modes may be prepared to separately control parameters in the generating means 12 and parameters in the identifying means 14, or to control parameters in both.

Thus, by enabling processing parameter control in the generating means 12 and the identifying means 14 (or also in the coordinate calculating means 16), the processing device 10 can be realized to suitably satisfy target characteristics according to the performance of the processing device 10 (hardware), required object detecting performance (e.g., TP (TruePositive) basis/FP (FalsePositive) basis), required processing speed, and the like.

As mentioned above, the result of red-eye region detection obtained by the identifying means 14 (a mask image indicating a red-eye region) is supplied to the coordinate calculating means 16.

The coordinate calculating means 16 converts the input image red-eye region detected by the identifying means 14 to positional coordinates and outputs the coordinates to a given block, e.g., a block located in the following stage and performing red-eye correction. The conversion from region data to positional coordinate values may be achieved by a known method.

Hereinafter, operations of the processing device 10 will be described. The program of the present invention is a program for causing a computer etc. to execute the following processes.

Preferably, when installed in a computer etc., the program of the present invention detects hardware performance (CPU performance, memory capacity, etc.), like software that performs benchmarking, and controls parameters in the generating means 12 and the identifying means 14. For example, when hardware performance is low, the program controls parameters to reduce the amounts of operations to shorten the processing time, e.g., by reducing the number of processed images generated and by reducing the number of rules used by identifying functions. On the other hand, when hardware performance is sufficient, the program controls parameters to perform sufficient operations to satisfy required performance, like TP basis or FP basis.

As mentioned above, the input image is supplied to the generating means 12. Then, the generating means 12 processes the input image to generate processed images that are enlarged/reduced by 5% pitch, as a 95% image, a 105% image, and so on, and sequentially supplies the input image (reference image) and the generated processed images to the identifying means 14. Also, the generating means 12 generates processed images by turning the input image and the enlarged/reduced processed images by 5° pitch from −30° to +30′ (two kinds of turned images including rotated and skewed images) and sequentially supplies the processed images to the identifying means 14 similarly to the above.

Receiving the processed images, the identifying means 14 first performs face detection from the image using the identifying function 1 and the dictionary data 1, and next detects an eye from the detected face using the identifying function 2 and the dictionary data 2. Then, the identifying means 14 detects a red-eye region from the detected eye using the identifying function 3 and the dictionary data 3.

When finishing red-eye detection about all processed images, the identifying means 14 merges the detection results about all processed images to detect a red-eye region in the input image and supplies the detection result to the coordinate calculating means 16. The result of the red-eye region detection supplied to the coordinate calculating means 16 is in the form of a mask image with “1” for the red-eye region and “0” for the remaining region, for example.

Receiving the result of the red-eye region detection, the coordinate calculating means 16 performs coordinate conversion to obtain the coordinates of the red-eye position and supplies the coordinates of the red-eye position to the following means, e.g., a following red-eye correcting means as described above.

In the processing device 10 of FIG. 1, the generating means 12 generates a plurality of processed images from the input image and the identifying means processes them. According to another embodiment of the present invention, the generating means 12 may be omitted and the identifying means processes the input image using identifying functions that render the input image equivalent to various kinds of processed images shown above.

According to this embodiment, for example, the identifying means is previously provided with identifying functions that perform processes corresponding to the above-described processed images, e.g., an identifying function corresponding to the input image (reference image), an identifying function that renders the input image with varied mask sizes, parameters, etc. equivalent to a 95% scaled image, a similar identifying function for a 105% image, a similar identifying function for a 90% image, and so on, and the input image is processed by those identifying functions to detect the object.

This embodiment requires a large number of identifying functions and pieces of dictionary data in the identifying means but eliminates the need for the generation of processed images, thus eliminating the need for the generating means 12 and shortening the processing time.

While the image processing method, image processing device, and program therefor of the present invention have been described in detail, it is understood that the embodiments are illustrative and not restrictive and that various modifications and improvements can be made without departing from the gist of the present invention.

For example, while the embodiment illustrated in the drawing performs face detection, eye detection, and red-eye detection, the present invention is not limited thereto and may be applied to detection of various objects, such as people, a nose, a mouth, animals like dogs and cats, flowers, etc. That is, the present invention is suitably applicable to various recognition type image processing.

1. An image processing device, comprising:
processed image generating means for generating plural processed images from a single input image;
identifying means having at least one identifying function and at least one piece of dictionary data for each of said at least one identifying function and processing each of said plural processed images generated by said processed image generating means using a combination of an identifying function corresponding to a target object in said at least one identifying function and said at least one piece of dictionary data for said identifying function to detect said target object in said single input image; and
coordinate calculating means for calculating positional coordinates of said target object in said single input image using a result of detecting said target object by said identifying means.

2. The image processing device according to claim 1, wherein each of said plural processed images includes at least one of an enlarged image of said single input image, a reduced image of said single input image, and a turned image obtained by turning said single input image.

3. The image processing device according to claim 1, wherein said identifying function includes at least one of a first identifying function for detecting a face and a second identifying function for detecting an eye, and said dictionary data includes at least one of first dictionary data for a race, second dictionary data for a gender, third dictionary data for an age, fourth dictionary data for weather, fifth dictionary data for a species of creature, and sixth dictionary data for a particular subject for photographing.

4. The image processing device according to claim 1, further comprising: at least one of changing means for changing number of said plural processed images generated by said processed image generating means and adjusting means for adjusting processing performed by said identifying function.

5. An image processing device, comprising:
identifying means having at least one identifying function that is set for one of plural images obtained by geometrically deforming an input image and at least one piece of dictionary data for each of said at least one identifying function and processing said input image using a combination of an identifying function corresponding to a target object in said at least one identifying function and said at least one piece of dictionary data for said identifying function to detect said target object in said input image; and
coordinate calculating means for calculating positional coordinates of said target object in said input image using a result of detecting said target object by said identifying means.

6. The image processing device according to claim 5, wherein each of said plural images obtained by geometrically deforming said input image includes at least one of an enlarged image of said input image, a reduced image of said input image, and a turned image obtained by turning said input image.

7. The image processing device according to claim 5, wherein said identifying function includes at least one of a first identifying function for detecting a face and a second identifying function for detecting an eye, and said dictionary data includes at least one of first dictionary data for a race, second dictionary data for a gender, third dictionary data for an age, fourth dictionary data for weather, fifth dictionary data for a species of creature, and sixth dictionary data for a particular subject for photographing.

8. The image processing device according to claim 5, further comprising: at least one of changing means for changing number of said plural images obtained by geometrically deforming said input image and adjusting means for adjusting processing performed by said identifying function.

9. An image processing method, comprising the steps of:
setting in advance at least one identifying function and at least one piece of dictionary data for each of said at least one identifying function;
generating plural processed images from a single input image;
processing each of said plural processed images generated by said generating step using a combination of an identifying function corresponding to a target object in said at least one identifying function set in advance and said at least one piece of dictionary data for said identifying function;
detecting said target object in said single input image; and
calculating positional coordinates of said target object in said single input image using a result of detecting said target object by said detecting step.

10. An image processing method, comprising the steps of:
setting in advance at least one identifying function for one of plural images obtained by geometrically deforming an input image and at least one piece of dictionary data for each of said at least one identifying function;
processing said input image using a combination of an identifying function corresponding to a target object in said at least one identifying function and said at least one piece of dictionary data for said identifying function;
detecting said target object in said input image; and
calculating positional coordinates of said target object in said input image using a result of detecting said target object by said detecting step.

11. A program for executing an image processing method, said image processing method comprising:
a step of setting in advance at least one identifying function and at least one piece of dictionary data for each of said at least one identifying function;
a step of generating plural processed images from a single input image;
a step of processing each of said plural processed images generated by said generating step using a combination of an identifying function corresponding to a target object in said at least one identifying function set in advance and said at least one piece of dictionary data for said identifying function;
a step of detecting said target object in said single input image; and
a step of calculating positional coordinates of said target object in said single input image using a result of detecting said target object by said detecting step.

12. The program according to claim 11, wherein said image processing method further comprises:
a step of detecting performance of a device in which said program is installed; and
at least one step of a step of selecting number of said plural processed images generated by said generating step and a step of adjusting processing performed by said identifying function, according to said detected device performance.

13. A program for executing an image processing method, said image processing method comprising:
a step of setting in advance at least one identifying function for one of plural images obtained by geometrically deforming an input image and at least one piece of dictionary data for each of said at least one identifying function;
a step of processing said input image using a combination of an identifying function corresponding to a target object in said at least one identifying function and said at least one piece of dictionary data for said identifying function;
a step of detecting said target object in said input image; and
a step of calculating positional coordinates of said target object in said input image using a result of detecting said target object by said detecting step.

14. The program according to claim 13, wherein said image processing method further comprises:
a step of detecting performance of a device in which said program is installed; and
at least one of a step of selecting number of operations deforming said input image and a step of adjusting processing performed by said identifying function.
